(19) United States
(12) Patent Application Publication
(10) Pub. No.: US 2006/0293438 A1
(43) Pub. Date: Dec. 28, 2006

(54) Carrier tapes and compositions thereof

(75) Inventor: Jose P. de Souza, Austin, TX (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/159,578

(22) Filed: Jun. 23, 2005

(51) Int. Cl. C09B 67/00

(52) U.S. Cl. 524/502; 524/495

(57) ABSTRACT

The present invention is a composition that includes polycarbonate constituting about 65% to about 85% by weight of the composition, polyester constituting about 1% to about 10% by weight of the composition, polyalkyl acrylate constituting about 1% to about 10% by weight of the composition, and carbon black constituting about 10% to about 20% by weight of the composition. The weight percents are based on the entire weight of the composition.

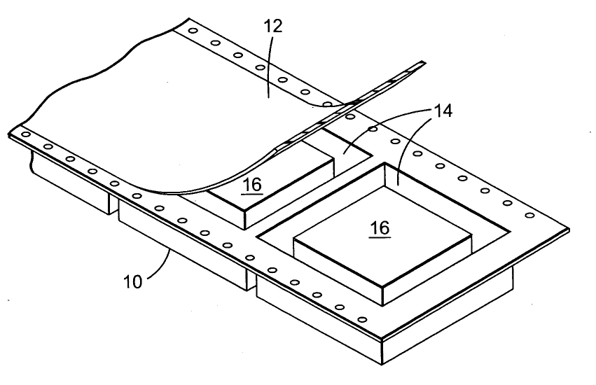

### FIELD

The present invention relates generally to carrier tapes of the kind having a plurality of pockets spaced longitudinally on the tape for accommodating components therein. More particularly, the invention relates to the composition of carrier tapes having reduced overall outgassing and high impact resistance.

### BACKGROUND

In general, carrier tapes that are used to hold and transport components are well known. For example, in the field of electronics circuit assembly, electronic components are often carried from a supply of components to a specific location on a circuit board for attachment thereto. The components may be of several different types, including surface mount components. Particular examples include memory chips, integrated circuit chips, resistors, connectors, processors, capacitors, gate arrays, etc.

For formulating a conductive carrier tape, it is known to use methyl methacrylate butadiene styrene (MBS) impact modified polycarbonate formulations. However, use of MBS often leads to a resin with high species outgassing and low impact resistance. When the carrier tape formulation produces high overall outgassing, residue quickly builds up on the forming tools and the equipment must be shut down in order to clean the forming tools. Whenever a process must be stopped, run times, and thus yield, are decreased. The high overall outgassing concentration of the carrier tape is due in part to the low thermal stability of the resin that is used to form the carrier tape.

The carrier tape is subject to normal wear and tear during transportation of the components. Thus, a carrier tape with low impact resistance is liable to breakage or other damage.

### SUMMARY

In one embodiment, the present invention is characterized as a composition that includes polycarbonate constituting about 65% to about 85% by weight of the composition, polyester constituting about 1% to about 10% by weight of the composition, polyalkyl acrylate constituting about 1% to about 10% by weight of the composition, and carbon black constituting about 10% to about 20% by weight of the composition. The weight percents are based on the entire weight of the composition.

In one embodiment, the present invention is characterized as a composition that includes polycarbonate, polyester, polyalkyl acrylate, and carbon black constituting about 10% to about 20% by weight of the composition. The composition exhibits an impact resistance of at least 1 foot-pound/inch when tested pursuant to ASTM D256-00.

In yet another embodiment, the present invention is characterized as a carrier tape that includes a layer having a plurality of component receivable pockets disposed on one side of the carrier tape. The layer is formed of a composition comprising polycarbonate, polyester, polyalkyl acrylate, and carbon black constituting about 10% to about 20% by weight of the composition.

In yet another embodiment, the invention is characterized as a film comprising polycarbonate constituting about 65% to about 85% by weight of the composition, polyester constituting about 1% to about 10% by weight of the composition, polyalkyl acrylate constituting about 1% to about 10% by weight of the composition, and carbon black constituting about 10% to about 20% by weight of the composition. The weight percents are based on the entire weight of the composition.

The above summary is not intended to describe each disclosed embodiment of every implementation of the present invention. The FIGURE and detailed description that follow more particularly exemplify illustrative embodiments.

### BRIEF DESCRIPTION OF THE DRAWINGS

The FIGURE is a perspective view of a carrier tape derived from the composition of the present invention.

While the above-identified FIGURE sets forth an embodiment of the invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The FIGURE may not be drawn to scale.

### DETAILED DESCRIPTION

The FIGURE is a perspective view of carrier tape 10 of the present invention in use with cover tape 12 and electrical components 16. Carrier tape 10 is derived from a composition of the present invention and includes a plurality of pockets 14 for storing electrical components 16 between carrier tape 10 and cover tape 12 during transport. Carrier tape 10 formed from the composition of the present invention is easy to manufacture due in part to its reduced species outgassing. The reduced species outgassing of carrier tape 10 results in stronger materials and minimal build-up of residue on forming tools. The minimal build-up of residue leads to longer run times between tool clean-up and extended tool life. Carrier tape 10 also has high impact resistance, making carrier tape 10 durable and capable of handling the normal wear and tear involved in transportation of electrical components 16.

By increasing the impact resistance of the resin used to form the carrier tape, the resistance to puncture and breakage during carrier tape handling is increased. These characteristics make carrier tape 10 particularly useful for the storage and delivery of small electronic components by an advancement mechanism.

The composition of the present invention includes polycarbonate, polyester, polyalkyl acrylate, and carbon black. The composition of carrier tape 10 of the present invention has high adhesive compatibility with cover tape 12, resulting in a more effective seal between carrier tape 10 and cover tape 12.

All concentrations herein are expressed in weight percent, unless otherwise stated. Suitable component concentrations in the composition of the present invention range from about 65% to about 85% polycarbonate, about 1% to about 10% polyester, about 1% to about 10% polyalkyl acrylate, and about 10% to about 20% carbon black, based on the total compositional weight of the composition of the present invention. Particularly suitable component concentrations in the composition of the present invention range from about 70% to about 80% polycarbonate, about 3% to about 7% polyester, about 1% to about 8% polyalkyl acrylate, and about 13% to about 18% carbon black, based on the total compositional weight of the composition of the present invention. Those skilled in the art will appreciate suitable component concentrations ranges for obtaining comparable physical properties of the manufactured articles.

Examples of suitable polycarbonates for the present invention include high molecular weight aromatic polycarbonate resins, such as polycarbonates prepared from diphenylolpropane or bisphenol-A. Examples of suitable commercially available polycarbonates include polycarbonates under the trade designation LEXAN, from General Electric, Fairfield, Conn., and under the trade designation MAKROLON, from Bayer Material Science, Columbia, Ill.

Examples of suitable polyesters include poly(butylene terephthalates). Examples of suitable commercially available polyesters include polyesters under the trade designation ULTRADUR from BASF Corporation, Florham Park, N.J., and under the trade designation CRASTIN from DuPont, Wilmington, Del.

Examples of suitable polyalkyl acrylates for the present invention include alkyl acrylates with alkyl groups of methyl, ethyl, propyl, isopropyl, n-butyl, isobutyl, 2-ethylhexyl, copolymers thereof, and combinations thereof. Examples of particularly suitable alkyl groups include methyl, n-butyl, and 2-ethylhexyl. As defined herein, the term “alkyl acrylate” also includes methacrylates. Examples of suitable polyalkyl acrylate copolymers include poly(ethylene methyl acrylates). Examples of suitable commercially available poly(ethylene methyl acrylates) include copolymers under the trade designation EMAC from Eastman Chemical Co., Kingsport, Tenn., and under the trade designation ELVALOY from DuPont, Wilmington, Del.

Examples of suitable carbon blacks are commercially available under the trade designation CONDUCTEX from Columbian Chemicals Company, Marietta, Ga., and under the trade designation VULCAN from Cabot Corporation, Boston, Mass. Carbon black is added to achieve surface resistivity for carrier tape 10 in either the conductive or static-dissipative range as defined by industry standard ANSI/ESD S541-2003.

The composition of the present invention may also include additional materials in varying concentrations as individual needs may require. For example, the composition of the present invention may further include pigments, coloring agents, ultraviolet light stabilizers, antioxidants, processing aids, fiberglass, mineral fillers, anti-slip agents, plasticizers, flame retardants, reinforcing agents, and combinations thereof. Examples of suitable antioxidants include antioxidants commercially available under the trade designations IRGANOX from Ciba Specialty Chemicals, Tarrytown, N.Y.

Outgassing involves the release of a gas trapped in a material caused either through heating of the material or subjecting the material to low pressure. When the material is heated, some of the components forming the material are volatilized due to the thermal instability of the components. Outgassing can lead to loss of vital components of the material, bubbles forming in the material, or to condensation of the volatilized components on equipment during production of the material.

The composition of the present invention exhibits low levels of outgassing due to the low amounts of volatile components in the composition. Volatile components are materials that have low thermal stability, thereby causing the materials to volatilize from the overall composition when heated. Varying the additives used in the composition can also control the level of outgassing.

The total outgassing concentration of the composition of the present invention may be measured by heating the composition and measuring the concentration of the headspace gas. An example of a suitable technique for measuring the outgassing concentration of the composition involves placing a sample of the composition in a gas chromatography oven. The oven may then be ramped from an initial temperature (e.g., about 40° C.) to a final temperature (e.g., about 200° C.) at a suitable ramp rate (e.g., about 30° C. per minute). The sample may then be held at 200° C. for about 60 minutes. After the heating period, the sample may then be cooled to room temperature (i.e., 25° C.), and then reheated to about 120° C. for about 60 minutes. An example of a suitable system for measuring the concentrations of the volatilized components includes a Hewlett Packard 6890 Gas Chromatograph with a Flame Ionization Detector (GC-FID), commercially available from Hewlett-Packard Company, Palo Alto, Calif., which includes a Hewlett Packard 7694 headspace sampler, and a J&W DB-5 column, having a 15 meter length, a 0.53 millimeter inner diameter, and a 1.50 micrometer film thickness.

Examples of suitable total outgassing concentrations of the composition include concentrations of less than about 150 parts-per-million (ppm) by weight when measured pursuant to the above-discussed chromatography method and using a headspace gas injection volume of 1.0 milliliter. The reduced outgassing of carrier tape 10 increases manufacturing effectiveness by reducing the amount of residue being deposited on the forming tools used to form carrier tape 10. The residue may transfer to carrier tape 10 during the forming process, resulting in poor quality for the carrier tape user. Moreover, the reduced outgassing also prevents a reduction in strength of carrier tape 10, which may otherwise occur if components of the composition of carrier tape 10 volatilize.

The composition of the present invention also provides high impact resistance. An example of the high impact resistance of the composition is at least 1 foot-pound/inch, when tested pursuant to the Notched Izod impact test disclosed in ASTM D256-00. Carrier tapes having high impact resistance are more durable and capable of withstanding abuse when transporting components 16 to their destination. When carrier tape 10 is moved from location to location, there is a decreased likelihood that carrier tape 10 will break and that components 16 within carrier tape 10 will be damaged.

The composition of the present invention may be blended and compounded with the use of an extruder. An example of a suitable extruder includes a trade designated BERSTORFF 40MM ZE 40-A co-rotating, intermeshing twin-screw extruder, commercially available from Berstorff, Florence, Ky. The extruder is desirably fitted with a screw configuration to substantially disperse the carbon black within the polymer resin. A suitable melt temperature for the extruder includes about 320° C. Calibrated loss in weight feeders may be used to feed the components of the composition at the appropriate ratios. The hot strands exiting the die may then be water quenched and palletized. The resulting pellets of the composition of the present invention are typically about 3.5 millimeters in length and about 3.0 millimeters in diameter.

To form carrier tape 10, the pellets may be fed into a single screw extruder. An example of a suitable extruder includes a Davis Standard 2.5-inch (6.4-centimeter) diameter single screw extruder having a length/diameter ratio of 30:1. A rising temperature profile may be used in the extruder die zones, which reaches a final temperature of about 232° C. The molten polymer may pass through a heated neck tube into a 10-inch wide film die block shimmed to a nominal gap of 0.070 inches (1.78 millimeters). The web melt emerging from the extruder die block may be drop cast into a nip formed by an aluminum forming tool and a silicone rubber covered nip roll. The silicone rubber desirably has a Shore A hardness of about 75. The tool roll temperature may be maintained at about 38° C., while the nip roll temperature may be maintained at about 21° C. After exiting the nip, the web continues around the curved surface of the tool as it is cooled by contact with a chilled forming tool, and also by external compressed air cooling until a temperature of less than the glass transition temperature of the material (approximately 100° C.) is reached. The web may then be removed from the tool and wound into a roll.

In an alternative embodiment of the present invention, the pellets of the composition may be extruded to form films of the present invention that do not contain pockets 14 for storing electrical components 16. The films of the present invention may be extruded in the same manner as discussed above for carrier tape 10, without drop casting the extruded web. The films of the present invention also exhibit low levels of outgassing and good impact resistance, and may be used for a variety of industrial and commercial purposes, including production of carrier tapes using standard thermoforming processes.

Although the illustrative embodiment of discussed above refers to carrier tapes (e.g., carrier tape 10) for use with electronic components, it is understood that the component carriers may be adapted for use with materials or substances of any type. For example, the features and materials of the component carriers may be adapted for use with liquid sample materials.

### EXAMPLES

The present invention is more particularly described in the following examples that are intended as illustrations only, since numerous modifications and variations within the scope of the present invention will be apparent to those skilled in the art. Unless otherwise noted, all parts, percentages, and ratios reported in the following examples are on a weight basis, and all reagents used in the examples were obtained, or are available, from the chemical suppliers described below, or may be synthesized by conventional techniques.

The following compositional abbreviations are used in the following Examples:
“PC”: A polycarbonate, commercially available under the trade designation MAKROLON 2600 from Bayer Material Science, Columbia, Ill.
“PBT”: A poly(butylene terephthalate), commercially available under the trade designation CRASTIN PBT 6130 from DuPont, Wilmington, Del.
“EMA”: A poly(ethylene methyl acrylate) commercially available under the trade designation ELVALOY 1125AC from DuPont, Wilmington, Del.
“LDPE”: A low density polyethylene commercially available under the trade designation DOWLEX 2035 from Dow Chemical Co., Danbury, Conn.
“MBS EXL”: A methyl methacrylate butadiene styrene commercially available under the trade designation PARALOID EXL-3691A from Rohm & Haas, Philadelphia, Pa.
“MBS BTA”: A methyl methacrylate butadiene styrene commercially available under the trade designation PARALOID BTA 753 from Rohm & Haas, Philadelphia, Pa.
“Carbon Black”: Carbon black commercially available under the trade designation CD-7055 ULTRA from Columbian Chemicals Company, Marietta, Ga.
“AO 1010”: An antioxidant commercially available under the trade designation IRGANOX 1010 from Ciba Specialty Chemicals, Tarrytown, N.Y.
“AO XP-620”: An antioxidant commercially available under the trade designation IRGANOX XP-620 from Ciba Specialty Chemicals, Tarrytown, N.Y.

### Examples 1-3 and Comparative Examples A-I

Compositions of Examples 1-3 of the present invention and Comparative Examples A-I were each prepared by mixing the components until the composition was blended. The component concentrations for Examples 1-3 are provided in Table 1 and the component concentrations of Comparative Examples A-I are provided in Tables 2 and 3.

TABLE 1

| Component | Example 1 | Example 2 | Example 3 |
|---|---|---|---|
| PC | 77.25 | 75.75 | 72.75 |
| PBT | 5.00 | 5.00 | 5.00 |
| EMA | 1.50 | 3.00 | 6.00 |
| Carbon Black | 16.00 | 16.00 | 16.00 |
| AO 1010 | 0.25 | 0.25 | 0.25 |

TABLE 2

| | Comparative | Comparative | Comparative | Comparative | Comparative |
|---|---|---|---|---|---|
| Component | Example A | Example B | Example C | Example D | Example E |
| PC | 77.75 | 77.75 | 77.75 | 77.75 | 77.75 |
| EMA | 1.50 | 1.50 | 0.00 | 1.50 | 1.50 |
| LDPE | 0.00 | 0.00 | 1.50 | 0.00 | 0.00 |
| MBS EXL | 0.00 | 0.00 | 0.00 | 4.50 | 4.50 |
| MBS BTA | 4.50 | 4.50 | 4.50 | 0.00 | 0.00 |
| Carbon Black | 16.00 | 16.00 | 16.00 | 16.00 | 16.00 |
| AO 1010 | 0.25 | 0.00 | 0.25 | 0.25 | 0.25 |
| AO XP-620 | 0.00 | 0.25 | 0.00 | 0.00 | 0.00 |

TABLE 3

| | Comparative | Comparative | Comparative | Comparative |
|---|---|---|---|---|
| Component | Example F | Example G | Example H | Example I |
| PC | 79.00 | 84.00 | 82.50 | 78.00 |
| PBT | 5.00 | 0.00 | 0.00 | 0.00 |
| EMA | 0.00 | 0.00 | 1.50 | 6.00 |
| Carbon Black | 16.00 | 16.00 | 16.00 | 16.00 |

The compositions of Examples 1-3 and Comparative Examples A-I were each compounded at a melt temperature 320° C. using a twin-screw extruder. The twin-screw extruder was a trade designated BERSTORFF 40MM ZE 40-A co-rotating, intermeshing twin-screw extruder commercially available from Berstorff, Florence, Ky., which was fitted with a screw configuration designed to disperse the carbon black dispersion. Calibrated loss in weight feeders were used to feed the components at the appropriate ratios. The hot strands exiting the die were water quenched and then pelletized to about 3.5 millimeters in length and about 3.0 millimeters in diameter.

### Outgassing Testing of Example 2 and Comparative Examples A-E

Pellets of the compositions of Example 2 and Comparative Examples A-E were quantitatively measured for outgassing by the following procedure to determine the thermal stability of the compositions. Pellets of each composition were placed into a tarred headspace vial and sealed. Each vial was then placed into a gas chromatography oven. The gas chromatography oven ramped from an initial temperature of 40° C. to a final temperature of 200° C. at a ramp rate of 30° C. per minute. The sample then was held at 200° C. for 60 minutes. After the 60-minute period, the sample was cooled to 25° C., and then reheated at 120° C. for a second 60-minute period. Multiple headspace extractions were then performed in order to characterize the parameters necessary for quantitative headspace analysis.

The concentrations of the volatilized components were obtained with a Hewlett Packard 6890 Gas Chromatograph with a Flame Ionization Detector (GC-FID), commercially available from Hewlett-Packard Company, Palo Alto, Calif. The GC-FID included a Hewlett Packard 7694 headspace sampler, which injected 1.0 milliliter of the headspace gas onto a J&W DB-5 column, which had a 15 meter length, a 0.53 millimeter inner diameter, and a 1.50 micrometer film thickness. Table 4 provides the concentrations in parts-per-million of the individual volatilized components and the total concentration of volatilized components, which is the sum of the concentrations of the individual volatilized components, for the compositions of Example 2 and Comparative Examples A-E.

TABLE 4

| | Example | Comparative | Comparative | Comparative | Comparative | Comparative |
|---|---|---|---|---|---|---|
| Outgassed Component | 2 | Example A | Example B | Example C | Example D | Example E |
| Sulfurdioxide | 3.0 | 12.0 | 8.0 | 11.3 | 11.0 | 11.3 |
| Methyl methacrylate | 0.0 | 67.7 | 29.7 | 53.7 | 0.0 | 38.3 |
| Styrene | 0.3 | 6.3 | 2.1 | 4.9 | 3.1 | 14.3 |
| Acetaldehyde | 40.0 | 163.3 | 65.0 | 123.3 | 170.0 | 133.3 |
| Methyl 2-oxopropanoate | 0.0 | 10.4 | 8.5 | 8.4 | 9.6 | 6.2 |
| Benzaldehyde | 0.0 | 1.2 | 0.6 | 1.2 | 0.0 | 1.9 |
| Isobutene | 8.0 | 120.0 | 68.3 | 110.0 | 88.3 | 111.7 |
| Toluene | 0.1 | 1.1 | 0.6 | 0.9 | 0.8 | 1.9 |
| Phenol | 2.1 | 3.4 | 2.2 | 3.0 | 2.3 | 3.9 |
| Propenal | 0.7 | 2.6 | 1.8 | 1.9 | 2.2 | 2.0 |
| Furfural | 0.0 | 9.7 | 2.7 | 6.3 | 0.0 | 24.5 |
| Acetophenone | 0.9 | 2.9 | 2.1 | 2.5 | 2.5 | 1.4 |
| Benzene | 0.2 | 2.1 | 1.5 | 1.9 | 1.7 | 3.0 |
| Chlorobenzene | 72.7 | 70.3 | 67.7 | 66.0 | 62.3 | 10.0 |
| Total Concentration | 128.0 | 473.1 | 260.8 | 395.4 | 353.8 | 363.8 |

The data provided in Table 4 illustrates the reduced levels of outgassing exhibited by articles formed from the composition of the present invention. In particular, the composition of Example 2 had a total outgassing concentration of 128.0 ppm. As such, the composition of Example 2 is thermally stable and retains its strength when subjected to heated environments. A low outgassing concentration corresponds to a amount of residue deposition on forming tools used to produce the articles formed from the compositions of the present invention. Because the tools need to be cleaned less frequently, manufacturing efficiency and yield of carrier tape increases.

The outgassing concentrations are also affected by the amount of MBS present in the formulation. For example, the total outgassing concentration decreases by more than 3.5 times when comparing the composition of Example 2 (no MBS) and Comparative Example A (4.5% MBS BTA).

### Impact Resistance Testing of Examples 1-3 and Comparative Examples F-I

The compositions of Examples 1-3 and Comparative Examples F-I were quantitatively measured for impact resistance. The pellets of each composition were injection molded and tested for impact resistance pursuant to ASTM 256-00. Table 5 provides the impact resistance for the compositions of Examples 1-3 and Comparative Examples F-I.

TABLE 5

| | Impact Resistance | Impact Resistance |
|---|---|---|
| Composition | (foot-pound/inch) | (Joules/meter) |
| Example 1 | 2.3 | 122.8 |
| Example 2 | 6.0 | 322.2 |
| Example 3 | 9.3 | 498.4 |
| Comparative Example F | 1.8 | 94.3 |
| Comparative Example G | 1.1 | 60.3 |
| Comparative Example H | 1.9 | 102.5 |
| Comparative Example I | 5.3 | 284.6 |

The data provided in Table 5 illustrates the good impact resistance exhibited by articles formed from the compositions of the present invention. In particular, the article formed from the composition of Example 3 exhibited an impact resistance of 498.4 Joules/meter (J/m). The Notched Izod impact increased by over eight times when comparing Example 3 (6% EMA) and Comparative Example G (no EMA). The high impact resistances of the compositions of the present invention increase the durability of the resulting carrier tapes (e.g., carrier tape 10) and provide increased protection for the components transported in the carrier tapes.

The combination of reduced outgassing and high impact resistance show that the carrier tapes and films formed from the compositions of the present invention have high thermal stability and high durability. The reduced outgassing provides better manufacturing efficiency and strength retention, while the high impact resistance makes the carrier tape more resistant to damage.

Although the present invention has been described with reference to preferred embodiments, workers skilled in the art will recognize that changes may be made in form and detail without departing from the spirit and scope of the invention.

1. A composition comprising:
polycarbonate constituting about 65% to about 85% by weight of the composition;
polyester constituting about 1% to about 10% by weight of the composition;
polyalkyl acrylate constituting about 1% to about 10% by weight of the composition; and
carbon black constituting about 10% to about 20% by weight of the composition, wherein the weight percents are based on the entire weight of the composition.

2. The composition of claim 1, wherein the polycarbonate constitutes about 70% to about 80% by weight of the composition, based on the entire weight of the composition.

3. The composition of claim 1, wherein the polyester constitutes about 3% to about 7% by weight of the composition, based on the entire weight of the composition.

4. The composition of claim 1, wherein the polyester comprises poly(butylene terephthalate).

5. The composition of claim 1, wherein the polyalkyl acrylate constitutes about 1% to about 8% by weight of the composition, based on the entire weight of the composition.

6. The composition of claim 1, wherein the polyalkyl acrylate comprises poly(ethylene methyl acrylate).

7. The composition of claim 1, wherein the carbon black constitutes about 13% to about 18% by weight of the composition, based on the entire weight of the composition.

8. The composition of claim 1, wherein the composition exhibits an impact resistance of at least 1 foot-pound/inch when tested pursuant to ASTM D256-00.

9. A composition comprising:
polycarbonate;
polyester;
polyalkyl acrylate; and
carbon black constituting about 10% to about 20% by weight of the composition, based on the entire weight of the composition, wherein the composition exhibits an impact resistance of at least 1 foot-pound/inch when tested pursuant to ASTM D256-00.

10. The composition of claim 9, wherein the polycarbonate constitutes about 65% to about 85% by weight of the composition, based on the entire weight of the composition.

11. The composition of claim 9, wherein the polyester constitutes about 1% to about 10% by weight of the composition, based on the entire weight of the composition.

12. The composition of claim 9, wherein the polyester comprises poly(butylene terephthalate).

13. The composition of claim 9, wherein the polyalkyl acrylate constitutes about 1% to about 10% by weight of the composition, based on the entire weight of the composition.

14. The composition of claim 9, wherein the polyalkyl acrylate comprises poly(ethylene methyl acrylate).

15. The composition of claim 9, wherein the carbon black constitutes about 13% to about 18% by weight of the composition, based on the entire weight of the composition.

16. A carrier tape comprising:
a layer having a plurality of component receivable pockets disposed on one side thereof, wherein the layer is formed of a composition comprising:
polycarbonate;
polyester;
polyalkyl acrylate; and
carbon black constituting about 10% to about 20% by weight of the composition, based on the entire weight of the composition.

17. The carrier tape of claim 16, wherein the polycarbonate constitutes about 70% to about 80% by weight of the composition, based on the entire weight of the composition.

18. The carrier tape of claim 14, wherein the polyester constitutes about 1% to about 10% by weight of the composition, based on the entire weight of the composition.

19. The carrier tape of claim 16, wherein the polyester comprises poly(butylene terphthlate).

20. The carrier tape of claim 16, wherein the polyalkyl acrylate constitutes about 1% to about 10% by weight of the composition, based on the entire weight of the composition.

21. The carrier tape of claim 16, wherein the polyalkyl acrylate comprises poly(ethylene methyl acrylate).

22. The carrier tape of claim 16, wherein the carbon black constitutes about 13% to about 18% by weight of the composition, based on the entire weight of the composition.

23. The carrier tape of claim 16, wherein the layer exhibits an impact resistance of at least 1 foot-pound/inch when tested pursuant to ASTM D256-00.

24. A film, comprising:
polycarbonate constituting about 65% to about 85% by weight of the composition;
polyester constituting about 1% to about 10% by weight of the composition;
polyalkyl acrylate constituting about 1% to about 10% by weight of the composition; and
carbon black constituting about 10% to about 20% by weight of the composition, wherein the weight percents are based on the entire weight of the composition.

25. The film of claim 24, wherein the polyester comprises poly(butylene terephthlate), and wherein the polyalkyl acrylate comprises poly(ethylene methyl acrylate).
